(19) United States
(12) Patent Application Publication
(10) Pub. No.: US 2009/0178349 A1
(43) Pub. Date: Jul. 16, 2009

(54) LOADING DOCK SHELTER WITH RESTRAINED INNER CORNER

(76) Inventor: Timothy J. Schmidt, Dubuque, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/972,297

(22) Filed: Jan. 10, 2008

(51) Int. Cl. B65G 69/28; B65G 69/32

(52) U.S. Cl. 52/173.2; 14/71.1

(57) ABSTRACT

A dock shelter for sheltering a truck or trailer at a loading dock includes an elongate foam pad having a traverse cross-sectional area that is generally L-shaped. To ensure that the pad's wrap-around pliable cover remains generally up against an inside corner of the L-shaped pad, a fiberglass rod, or some other type of stiffening member, is installed along that corner. The cover includes an integral sleeve that contains the rod, while upper and lower fabric end caps help hold the rod snugly in the corner of the pad.

### FIELD OF THE DISCLOSURE

The subject disclosure generally pertains to loading dock shelters and more specifically to loading dock shelters that include a generally L-shaped foam pad encased within a pliable cover.

### BACKGROUND OF RELATED ART

When an exterior doorway of a building is used as a dock for loading and unloading trucks, the doorway often includes a dock shelter to shield against weather elements. A dock shelter seals off air gaps that might otherwise exist between the exterior face of the building and the back end of the truck when the truck engages the loading dock. Dock shelters often have two side members that line the lateral edges of the doorway and project outwardly from the face of the building. From the protruding front edge of each side member is a flexible seal member that extends into the truck's path leading to the doorway so that the seal members sealingly wipe against either side of the truck as the truck backs into the dock. In addition to the two side and seal members, a header mounted above the doorway helps seal or shelter the upper rear edge of the truck. The header can be constructed in a manner similar to that of the side and seal members, or the header may be constructed in a manner entirely different from the side and seal members.

Many side and seal members comprise a resiliently compressible foam pad having a traverse cross-section that is generally L-shaped, wherein the side and seal members make up the two legs of the L-shape. For protection against abrasion and weather elements, a sturdy pliable cover typically encases the L-shaped pad. U.S. Pat. No. 4,718,207, which is specifically incorporated by reference herein, discloses one example of an L-shaped dock shelter member. A design issue concerning L-shaped dock shelter members pertains to a possible lack of tautness of the pliable cover in the vicinity of the L-shape's inside corner. Specifically, when an L-shaped dock shelter member deflects in response to a truck backing into the dock, the deflection between the two legs of the L-shape can allow the pliable cover to slacken in this area. The slack material might catch on edges of the truck or simply be unsightly.

### BRIEF DESCRIPTION OF THE DRAWINGS

FIG. 1 is a perspective view of a vehicle backing into a loading dock.

FIG. 2 is a perspective view similar to FIG. 1 but showing the vehicle engaged with a dock shelter.

FIG. 3 is cross-sectional end view taken along line 3-3 of FIG. 1.

FIG. 4 is a cross-sectional view taken along line 4-4 of FIG. 2.

FIG. 5 is a perspective view showing the assembly of an L-shaped loading dock shelter member.

FIG. 6 is a perspective view similar to FIG. 5 but showing the loading dock shelter member after assembly.

### DESCRIPTION OF THE PREFERRED EXAMPLES

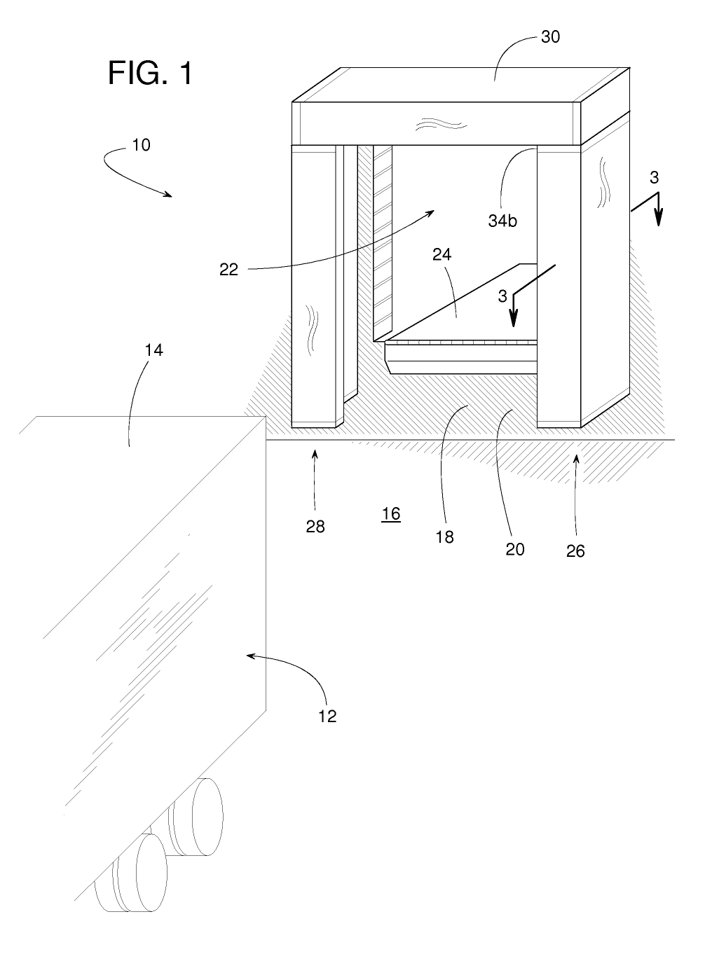

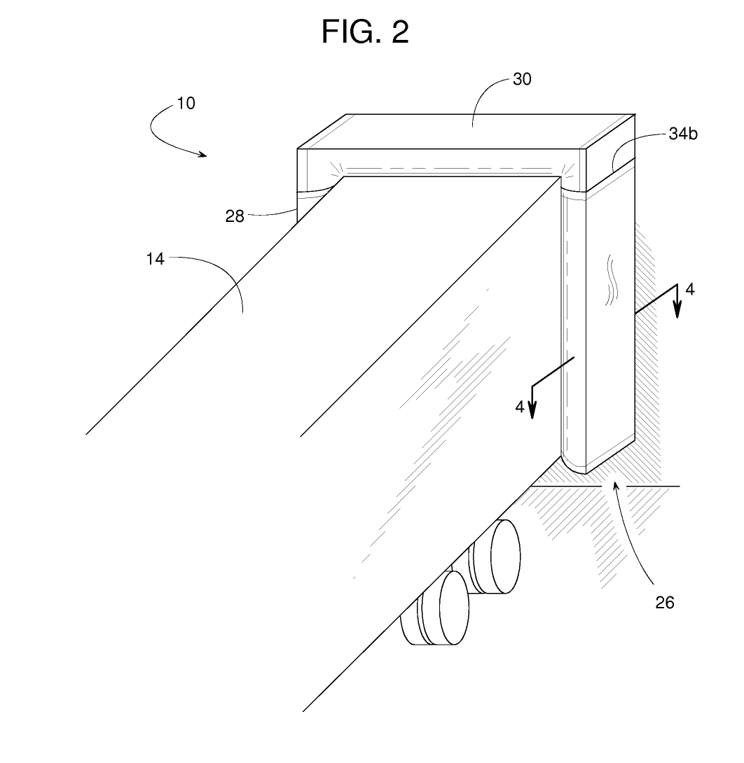

For protection against weather, a loading dock shelter 10, shown in FIGS. 1 and 2, can help shelter and/or seal a back end 12 of a vehicle 14 while cargo is loaded or unloaded from the vehicle. Vehicle 14 can be a truck, trailer or some other type of vehicle that has a rear access through which cargo can be transferred between the vehicle 14 and a loading dock 16. Loading dock 16 can be an area associated with a building 18 that includes a wall 20 with a doorway 22. Loading dock 16 might also include a conventional dock leveler 24 and various other well-known loading dock items, such as a door, vehicle restraint, bumpers, etc. FIG. 1 shows vehicle 14 backing into loading dock 16, and FIG. 2 shows the upper rear and sides of the vehicle's back end 12 engaging dock shelter 10.

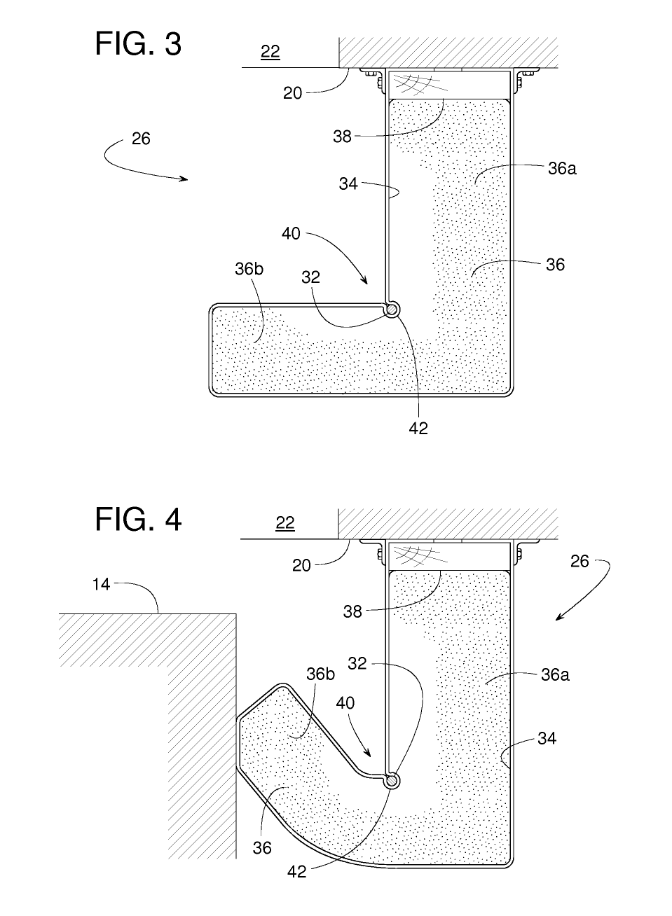

To seal and/or shelter the vehicle's 14 upper rear and side surfaces, dock shelter 10 includes a first or right-hand side member 26, a second or left-hand side member 28, and a header 30. Members 26, 28 and 30 can be constructed in a similar manner and/or one or more of the members 26, 28 and 30 can be constructed in a manner that is unique or different in relation to the other members. For example, right-hand side member 26 can be made of a resiliently compressible member constructed as shown in FIGS. 3-6, wherein side member 26 includes a novel elongate stiffening member 32 that helps neatly hold portions of a pliable cover 34 in place.

In this particular example, side member 26 comprises an elongate compressible pad 36 having a transverse cross-sectional area that is generally L-shaped (i.e., two adjoined legs extending in different directions). The two legs of the L-shape can be generally perpendicular to each other as illustrated in FIG. 3 or can be at any other suitable angle or position.

Pad 36 can be a substantially unitary piece, or it can be an assembly of two or more individual pieces. In either case, pad 36 can be comprised of a side pad 36a and a seal pad 36b. Seal pad 36b provides a lip that can resiliently deflect in reaction to vehicle 14 backing into dock shelter 10 and can sealingly conform to the vehicle's contour, as shown in FIG. 4. Side pad 36a preferably is a resiliently compressible structure for supporting seal pad 36b at a certain projected distance from wall 20. The resilient compressibility of side pad 36a enables side pad 36a to return to its original shape in the event that vehicle 14 backs directly into side pad 36a with a substantial or crushing force. Side pad 36a, seal pad 36b, and/or compressible pad 36 as a whole can be made of any suitable material, such as, for example, a natural or synthetic resiliently compressible polymer, examples of which include, but are not limited to a polyurethane or polyester foam.

A backer 38 made of wood, metal, plastic or any other material can be used for mounting side member 26 to wall 20.

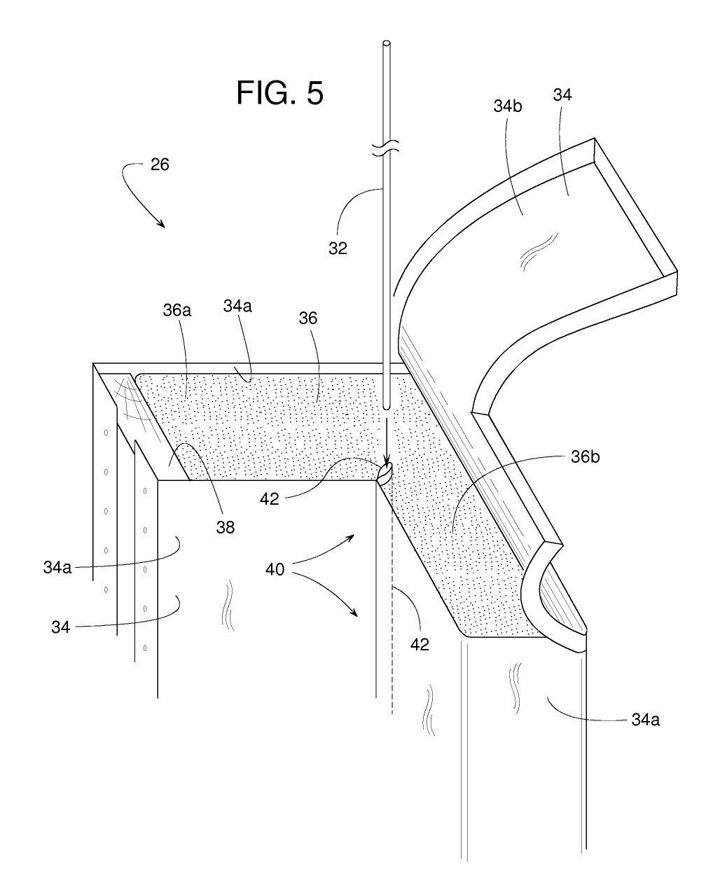

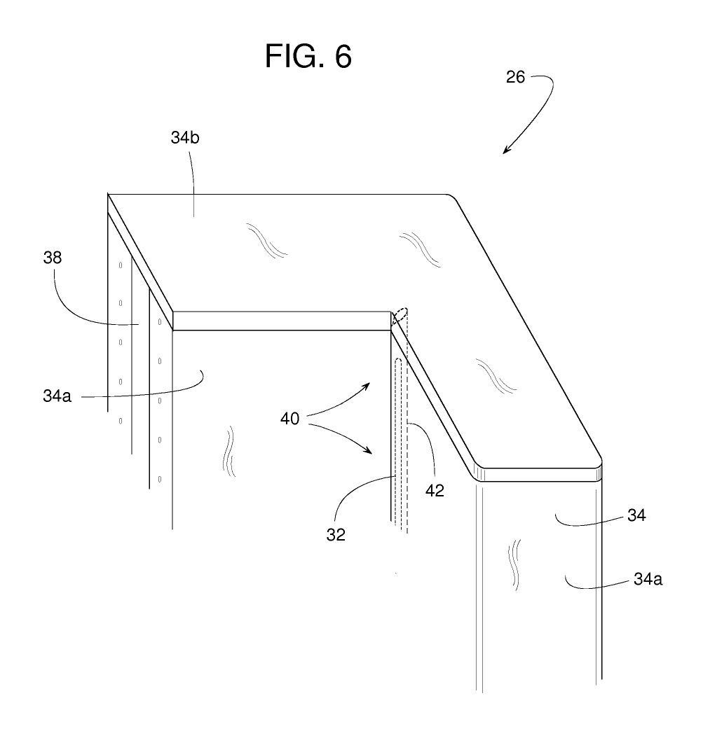

Pliable cover 34 helps protect pad 36 against abrasion and weather elements. Cover 34 can be made of any suitable material, examples of which include, but are not limited to, canvas duck or rubber impregnated nylon fabric. Referring to FIGS. 5 and 6, cover 34 can be comprised of a side sheet 34a that wraps around pad 36, and one or more end sheets 34b that cap either end of pad 36.

When vehicle 14 deforms pad 36, as shown in FIG. 4, cover sheet 34a might tend to billow outward away from an inner corner 40 of pad 36. This effect is most pronounced near the vertical center or the middle of the pad 36, since the fabric cover 34 is effectively unrestrained there. Compare this middle section of the inner corner 40 with the upper and lower ends of the inner corner 40, which are connected to and thus move with (and are restrained by) end sheets 34b. To help prevent this billowing of the inner corner 40, cover sheet 34a can be sewn and/or otherwise provided with a sheath or holder illustratively in the form of an elongate sleeve 42 that is disposed at corner 40 along at least a portion of the pad's length to facilitate attachment or coupling of the stiffening member 32 to the inner corner 40. Elongate stiffening member 32, which is more rigid than cover 34, can be inserted into sleeve 42 to extend along at least a portion and/or substantially along the entire length of the pad. Upon sewing or otherwise attaching end sheets 34b to side sheets 34a, end sheets 34b help hold stiffening member 32 at corner 40, thus holding cover sheet 34a there as well. In a sense, the member 32 and sleeve 42 work together to extend the restraint of the upper and lower ends of the inner corner 40 by the end sheets 34b along the whole vertical length of the inner corner 40. Without member 32 and sleeve 42, the middle portion of the inner corner is unrestrained from the billowing effect. Member 32 and sleeve 42 couple this middle portion to the end portions of the inner corner 40, which are restrained by their connections to the end sheets 34b. In this manner, member 32 provides an effectively continuous restraint along the vertical extent of the inner corner 40 by distributing the restraint enjoyed by the upper and lower ends of the inner corner 40 through the medium of the member 32, and facilitated by sleeve 42. Thus, the sleeve 42 couples the member 32 to the restrained upper and lower ends of the inner corner 40. In other example implementations, member 32 can be directly coupled to the restrained upper and lower ends of the inner corner (e.g. via chemical fasteners), but the use of vertically discrete or elongated holders (like sleeve 42) facilitate this coupling.

Although sleeve 42 and stiffening member 32 can be generally hidden between pad 36 and the exposed surface of cover 34, as illustrated in FIGS. 3-6, sleeve 42 could alternatively be installed at a position external to cover 34 and/or at a more visible location near corner 40. An external location might make stiffening member 32 more accessible for repair and/or replacement.

Elongate stiffening member 32 can be made of various materials including, but not limited to, fiberglass or metal. Stiffening member 32 can have various shapes including, but not limited to, tubular or solid cylindrical and can also have a traverse cross-sectional area that is L-shaped, square, rectangular, or channel shaped.

It should be noted that the structural features of right-hand side member 26 can also apply to left-hand side member 28 and/or header 30.

From the foregoing, it will be appreciates that example apparatus have been disclosed whereby, a loading dock shelter includes an elongate stiffening member that helps hold a pliable cover against an inside corner of an L-shaped compressible pad.

In some examples, the elongate stiffening member is held in place by the pliable cover itself.

In some examples, the pliable cover provides a simple, convenient sleeve for holding the elongate stiffening member.

In some examples, the elongate stiffening member is substantially hidden from view.

In some examples, the pliable cover shelters the elongate stiffening member from weather.

In some examples, the elongate stiffening member extends about the full length of the pad so that the cover's upper and lower end caps can be used to hold the elongate stiffening member against the pad's inside corner.

In some examples, the elongate stiffening member is made of a non-fabric material that is stiffer than the material of the cover so that the elongate stiffening member can provide the cover with appreciable support.

In some examples, a portion of the pliable cover lies between the elongate stiffening member and the foam pad so that the cover material itself can fully contain the elongate stiffening member.

In some examples, the elongate stiffening member is made of a corrosive-resistant and/or semi-rigid polymeric material.

In some examples, the elongate stiffening member is tubular for a greater stiffness to weight ratio.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A loading dock shelter mountable to a wall, the loading dock shelter comprising:
an elongate compressible pad having a transverse cross-sectional area that is generally L-shaped, which provides the elongate compressible pad with an inner corner that extends along a longitudinal length of the elongate compressible pad;
a pliable cover overlying the elongate compressible pad; and
an elongate stiffening member disposed adjacent to the inner corner and extending along the longitudinal length of the elongate compressible pad.

2. The loading dock shelter of claim 1, wherein the elongate compressible pad comprises a substantially unitary piece of foam.

3. The loading dock shelter of claim 1, wherein the elongate compressible pad comprises end sheets coupled to and restraining upper and lower ends of the inner corner, the elongate stiffening member being coupled to the upper and lower ends of the inner corner.

4. The loading dock shelter of claim 3, wherein the pliable cover includes an elongate sleeve to receive the elongate stiffening member, and couples the elongate stiffening member to the upper and lower ends of the inner corner.

5. The loading dock shelter of claim 1, wherein the elongate stiffening member extends along at least a portion of the longitudinal length of the elongate compressible pad.

6. The loading dock shelter of claim 1, wherein a portion of the pliable cover lies between the elongate stiffening member and the elongate compressible pad.

7. The loading dock shelter of claim 1, wherein the elongate stiffening member is stiffer than the pliable cover.

8. The loading dock shelter of claim 1, wherein the elongate stiffening member is comprised of a non-fabric material.

9. The loading dock shelter of claim 1, wherein the elongate stiffening member is comprised of a polymeric material.

10. The loading dock shelter of claim 1, wherein the elongate stiffening member is comprised of metal.

11. The loading dock shelter of claim 1, wherein the elongate stiffening member is a solid rod.

12. The loading dock shelter of claim 1, wherein the elongate stiffening member is a tube.

13. A loading dock shelter mountable to a wall that defines a doorway, the loading dock shelter comprising:
a right-hand foam pad and a left-hand foam pad, wherein the right-hand foam pad and the left-hand foam pad project outwardly away from the wall and extend toward each other when the loading dock shelter is mounted to the wall, the right-hand foam pad and the left-hand foam pad each define a longitudinal inner corner that generally faces the doorway;
a right-hand pliable cover overlying the right-hand foam pad;
a left-hand pliable cover overlying the left-hand foam pad; and
a first elongate stiffening member and a second elongate stiffening member disposed adjacent to the longitudinal inner corner of the right-hand foam pad and the left-hand foam pad respectively.

14. The loading dock shelter of claim 13, wherein the right-hand elongate foam pad is a unitary piece of foam.

15. The loading dock shelter of claim 13, wherein the right-hand pliable cover includes an elongate sleeve that contains the first elongate stiffening member.

16. The loading dock shelter of claim 13, wherein the first elongate stiffening member extends over most of a longitudinal vertical length of the right-hand foam pad.

17. The loading dock shelter of claim 13, wherein the first elongate stiffening member is stiffer than the right-hand pliable cover.

18. The loading dock shelter of claim 13, wherein the first elongate stiffening member is comprised of a non-fabric material.

19. The loading dock shelter of claim 13, wherein the first elongate stiffening member is comprised of a polymeric material.

20. The loading dock shelter of claim 13, wherein the first elongate stiffening member is a solid rod.

21. A loading dock shelter mountable to a wall, the loading dock shelter comprising:
an elongate foam pad having a traverse cross-sectional area that is generally L-shaped, which provides the elongate foam pad with an inner corner that extends along a longitudinal length of the elongate foam pad;
a pliable cover overlying the elongate foam pad, wherein the pliable cover includes an elongate sleeve adjacent to the inner corner; and
an elongate stiffening member disposed within the elongate sleeve and extending along at least a portion of the longitudinal length of the elongate foam pad, wherein the elongate stiffening member further comprises a non-fabric material and is stiffer than the pliable cover.

22. The loading dock shelter of claim 21, wherein the elongate foam pad is a unitary piece of foam.

23. The loading dock shelter of claim 21, wherein the elongate foam pad comprises a side foam pad and a seal foam pad, the side foam pad has a proximal edge that faces the wall when the loading dock shelter is mounted thereto, and the side foam pad has a distal edge adjoining the seal foam pad at the inner corner.

24. The loading dock shelter of claim 21, wherein the elongate stiffening member is comprised of a polymeric material.

25. The loading dock shelter of claim 21, wherein the elongate stiffening member is a solid rod.

26. The loading dock shelter of claim 21, wherein the elongate stiffening member is a tube.
